(19) United States
(12) Patent Application Publication
(10) Pub. No.: US 2024/0317499 A1
(43) Pub. Date: Sep. 26, 2024

(54) ROBOTIC VEHICLE-BASED CONCURRENT COMPLETION OF MULTIPLE PACKAGES

(71) Applicant: INTERNATIONAL BUSINESS MACHINES CORPORATION, Armonk, NY (US)

(72) Inventors: Katsuyuki Sakuma, Fishkill, NY (US); Sarbajit K. Rakshit, Kolkata (IN)

(21) Appl. No.: 18/186,863

(22) Filed: Mar. 20, 2023

(51) Int. Cl. B65G 1/137; B65G 1/04; G05B 19/4155

(52) U.S. Cl. CPC B65G 1/1378; B65G 1/0492; G05B 19/4155; B65G 2209/02; G05B 2219/50391

(57) ABSTRACT

Robotic vehicle-based package completion includes determining, using computer hardware, a number of packages required to fulfill a plurality of orders based on items included in the respective plurality of orders. Packages of the plurality of orders are assigned to a plurality of apertures of a packaging platform using the computer hardware. Routes for a plurality of robotic vehicles carrying items of the orders and configured to traverse a surface of the packaging platform are generated using the computer hardware. The plurality of robotic vehicles, in traversing the packaging platform based on the routes, are configured to deposit items of the orders into respective ones of the plurality of apertures assigned a package of the orders.

### BACKGROUND

This disclosure relates to using robotic vehicles to process orders and complete packages for the orders.

Many different types of commercial enterprises utilize order fulfillment systems to respond to received orders and efficiently fulfill the orders. As an example, an automated retail store (e.g., an online or web-based storefront or warehouse fulfillment center) uses an order fulfillment system to work on multiple orders at the same time. As a single order typically includes multiple different items, the ability to pull items for orders from available stock, package the items for delivery, and safely ship the packaged items to the recipient in an efficient manner is of great importance.

### SUMMARY

In one or more embodiments, a method includes determining, using computer hardware, a number of packages required to fulfill a plurality of orders based on items included in the respective plurality of orders. The method includes assigning, using the computer hardware, packages of the plurality of orders to a plurality of apertures of a packaging platform. The method includes generating, using the computer hardware, routes for a plurality of robotic vehicles configured to carry items of the orders and traverse a surface of the packaging platform. The plurality of robotic vehicles, in traversing the packaging platform based on the routes, are configured to deposit the items of the orders into respective ones of the plurality of apertures assigned a package of the orders.

In one or more embodiments, a system includes a packaging platform including a plurality of apertures. The system includes a plurality of robotic vehicles configured to carry items, traverse a surface of the packaging platform, and deposit the items into different ones of the apertures according to a plurality of orders. The system includes a computer system in communication with the plurality of robotic vehicles. The computer system is configured to generate routes for the plurality of robotic vehicles to traverse the surface of the packaging platform and deposit the items into the apertures.

In one or more embodiments, a system includes one or more processors configured to initiate executable operations. The executable operations include determining a number of packages required to fulfill a plurality of orders based on items included in the respective plurality of orders. The executable operations include assigning packages of the plurality of orders to a plurality of apertures of a packaging platform. The executable operations include generating routes for a plurality of robotic vehicles configured to carry items of the orders and traverse a surface of the packaging platform. The plurality of robotic vehicles, in traversing the packaging platform based on the routes, are configured to deposit the items of the orders into respective ones of the plurality of apertures assigned a package of the orders.

In one or more embodiments, a computer program product includes a computer readable storage medium having program instructions stored thereon. The program instructions are executable by one or more processors to cause the one or more processors to execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a system for fulfilling one or more orders.

FIG. 2 illustrates a cross-sectional side view of the packaging platform of FIG. 1 taken along cut-line 2.

FIG. 3 illustrates an example of an architecture for a product packaging engine executable by a data processing system.

FIG. 4 illustrates an example of routes generated by the product packaging engine of FIGS. 1 and 3.

FIG. 5 illustrates an example method of fulfilling orders using the system of FIG. 1.

FIG. 6 illustrates an example implementation of a computing environment for use with the inventive arrangements described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to using robotic vehicles to process orders and complete packages for the orders. In accordance with the inventive arrangements disclosed herein, methods, systems, and computer program products are disclosed that facilitate the efficient processing and fulfillment of orders. In one or more embodiments, a system is provided that includes a packaging platform. The packaging platform includes a plurality of apertures. Containers such as boxes, cartons, bags, or other suitable vessels for shipping products for orders, may be disposed beneath the apertures or attached to the bottom of the packaging platform in alignment with the apertures. A plurality of robotic vehicles configured to carry products are capable of traveling along a surface of the packaging platform.

In one or more example implementations, a product packaging engine is capable of analyzing received orders for products (e.g., items), determining compatibility among items in the received orders, determining relative positioning of items in packages for the orders (e.g., sequencing of items placed in containers), and determining the relative positions of different packages with respect to the apertures of the packaging platform for purposes of order fulfilment. The robotic vehicles are capable of operating under control of the product packaging engine to ensure that the robotic vehicles are able to fulfill orders with optimized movement.

For example, as the system receives orders, the orders may be processed to determine information such as the number of packages required to fulfill each order. The system is capable of assigning the packages to different ones of the apertures of the packaging platform. The system is also capable of generating routes for the robotic vehicles. The robotic vehicles are capable of traversing these routes and dropping products through apertures that correspond to orders that require those products. In this manner, multiple orders may be fulfilled concurrently. In addition, for orders that require two or more packages for fulfillment, the multiple packages of the order may be fulfilled concurrently.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

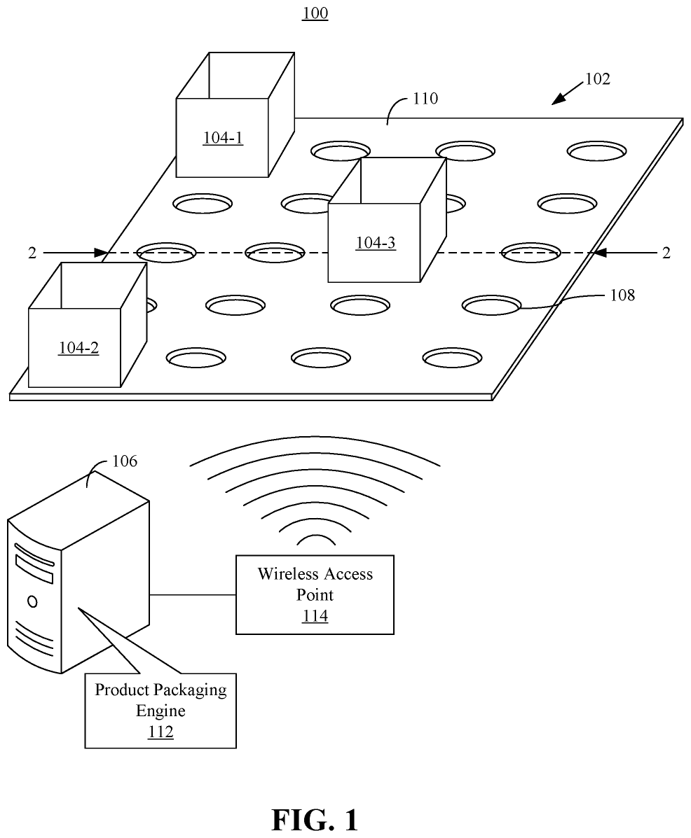

FIG. 1 illustrates an example of a system 100 that is capable of fulfilling one or more orders. In the example, system 100 includes a packaging platform 102, a plurality of robotic vehicles 104 (e.g., 104-1, 104-2, and 104-3), and a data processing system 106.

Packaging platform 102 includes a plurality of apertures 108. In one or more embodiments, apertures 108 are arranged in an array in a grid pattern as shown. Packaging platform 102 has a surface 110 (e.g., a top surface) on which robotic vehicles 104 may travel. Though not illustrated in the example, containers may be placed and/or disposed beneath each of the apertures 108. In other arrangements, containers may be attached to a bottom surface of packaging platform 102 beneath each respective aperture 108 or attached to packaging machines disposed beneath each respective aperture 108. Examples of containers may include, but are not limited to, boxes, cartons, bags, or other vessels that are suitable for shipping one or more items (e.g., products). For example, supports may be used to elevate packaging platform 102; packaging platform 102 may be suspended; or packaging platform 102 may be disposed in a larger platform or surface.

Packaging platform 102 may be formed of a material of sufficient strength and rigidity to support robotic vehicles 104 traveling over surface 110. In some arrangements, supporting structures may be added beneath packaging platform 102, e.g., between apertures 108, so as to provide packaging platform 102 with sufficient strength and rigidity to support robotic vehicles traveling over surface 110. The size of packaging platform 102 and robotic vehicles 104 may vary based on the size of products that may be specified on received orders. Further, it should be appreciated that the number of apertures 108, size of apertures 108, and/or spacing of apertures 108 included in packaging platform 102 may vary depending on the size of packaging platform 102, the number of products to be handled by system 100, and/or the size of products to be handled by system 100, and/or to provide robotic vehicles 104 with sufficient surface area over which to maneuver without getting stuck in and/or by apertures 108. For example, apertures 108 may be sized to be smaller than the distance between adjacent wheels of robotic vehicles 104 so that robotic vehicles 104 may straddle apertures 108 so that no wheel falls into an aperture 108 while robotic vehicles 104 move over apertures 108.

In one or more embodiments, each aperture 108 represents an entry passage for dropping the items for an order or for a package of an order. Within this disclosure, the term “package” means a group of one or more items of an order that are placed into a single and same container for shipping. Thus, an order may include one or more items (e.g., products). Each order may be fulfilled by grouping the items into one or more packages. Each container includes only items of a same package. The packages of the orders are assigned to different ones of apertures 108. For example, packages of orders may be assigned to apertures 108 on a one-to-one basis (e.g., using a one-to-one mapping of packages to apertures).

Robotic vehicles 104 may be implemented as autonomous and unmanned vehicles that are capable of traveling along a predetermined or programmed travel path referred to herein as a route. Robotic vehicles may be implemented as self-powered, wheeled carts that may include a cargo area in which items may be loaded to fulfill received orders. For example, robotic vehicles 104 may be pre-filled with different types of products. While moving on packaging platform 102, the robotic vehicles 104 are capable of identifying appropriate apertures 108, positioning the cargo area of the robotic vehicle above the aperture, and dropping appropriate product(s) for packages the orders into such apertures 108. Orders received by system 100 may be completed by multiple robotic vehicles 104 operating concurrently to drop packages through appropriate apertures 108. In one aspect, each robotic vehicle carries a single and different product. For example, robotic vehicle 104-1 may carry a product of a particular type (e.g., product A). Robotic vehicle 104-2 may carry a product of a different type (e.g., product B). Robotic vehicle 104-3 may carry a product of yet a different type (e.g., product C). In one or more other examples, one or more or all of the robotic vehicles 104 may carry more than one product and drop a selected product through apertures 108.

In one or more example implementations, each individual item carried by a robotic vehicle 104 may be uniquely identified. Accordingly, each robotic vehicle 104 is capable of dropping or releasing from the cargo area one or more products (of known identifiers) in a controlled manner.

In the example, each robotic vehicle 104 is capable of traveling along a route that visits one or more of apertures 108. As a robotic vehicle 104 traverses over a selected aperture 108, the robotic vehicle 104 is capable of releasing or dropping one or more of the products carried by the robotic vehicle 104 through the aperture 108. In one or more example implementations, each robotic vehicle 104 may have wheels configured to straddle apertures 108 so that each robotic vehicle 104 may travel over the apertures 108 without falling into the apertures 108 or otherwise getting stuck.

In one or more embodiments, robotic vehicles 104 may be configured or programmed to drop items in only certain ones of apertures 108 based on the particular order and/or package assigned to the various apertures 108. Robotic vehicles 104 may move over surface 110 of packaging platform 102 concurrently to drop products for a plurality of orders into apertures 108 to complete the plurality of orders at the same time (e.g., concurrently). In traversing a particular route, any one of robotic vehicles 104 may drop items into one or more different apertures 108 corresponding to one or more different packages and/or orders.

In the example, data processing system 106 may execute operational software such as an operating system and a product packaging engine 112. Product packaging engine 112 is capable of processing received orders to generate the routes traversed by robotic vehicles 104.

For purposes of illustration, data processing system 106 may be coupled to a wireless access point 114. Robotic vehicles 104 may be enabled for wireless communication and couple wirelessly to wireless access point 114. Through wireless access point 114, data processing system 106 may communicate with robotic vehicles 104 to provide route information and/or other instructions such as which apertures 108 of the route into which product(s) are to be dropped and a number of each such product to drop into the different apertures 108. Similarly, data processing system 106 may receive status information from robotic vehicles such as location information, number of items deposited into apertures 108 (e.g., real time data), and the like. In this manner, data processing system 106 and, more particularly, product packaging engine 112, is capable of knowing, in real time, how much product is carried by each respective robotic vehicle 104 at any given time.

It should be appreciated that use of wireless access point 114 within the example of FIG. 1 is for purposes of illustration only. Other techniques and/or technologies for communication between data processing system 106 executing product packaging engine 112 and robotic vehicles 104 may be used in place of and/or in addition to wireless access point 114 (e.g., WiFi). For example, Bluetooth or other wireless communication technologies may be used.

In the example, any of a variety of different location determination techniques and/or technologies may be used so that data processing system 106 is able to determine the locations of robotic vehicles on packaging platform 102 at any given time. Location determination may be performed periodically and/or in real time. As an example, Internet-of-Things (IoT) devices may be attached to robotic vehicles 104 so that data processing system 106 may determine positioning information from robotic vehicles 104 via such devices communicating data over a local area network and/or the Internet. In another example, camera-based monitoring of robotic vehicles 104 may be used in combination with image processing so that data processing system 106 may determine location information for robotic vehicles 104 on packaging platform 102 from the image data captured by the camera-based monitoring system. The camera-based monitoring system may capture images of platform 102 with robotic vehicles thereon and/or may include cameras mounted on the respective vehicles for navigation. In still another example, robotic vehicles 104 may include other location determination devices such as Global Positioning System (GPS) devices, transponders, or the like so that data processing system 106 may track the locations of robotic vehicles 104 for purposes of calculating routes and controlling the operation of such robotic vehicles 104.

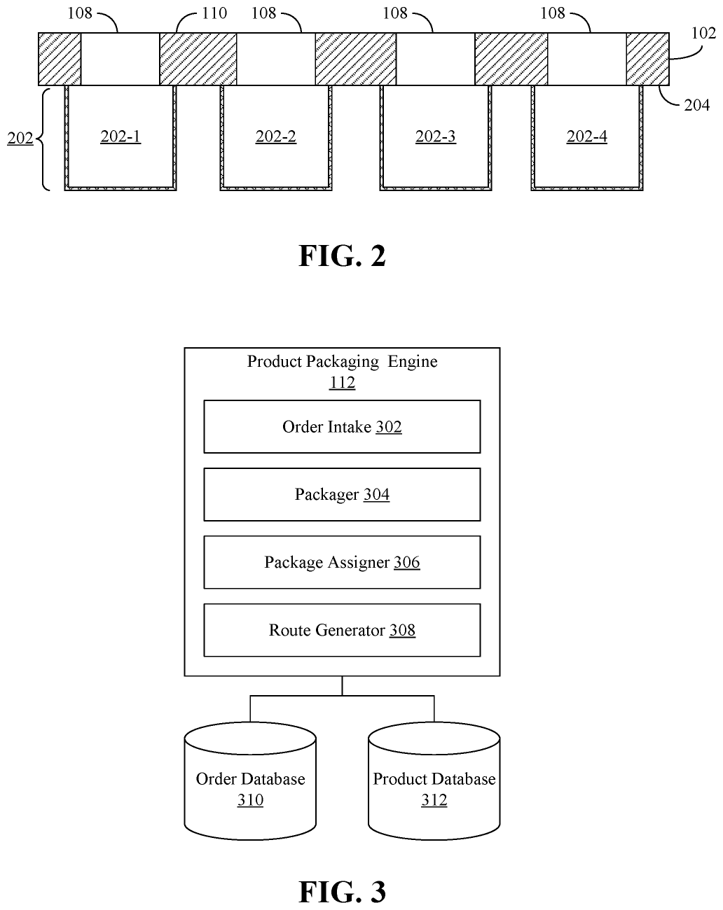

FIG. 2 illustrates a cross-sectional side view of packaging platform 102 of FIG. 1 taken along cut-line 2. In the example of FIG. 2, containers 202 are illustrated beneath apertures 108. As discussed, containers 202 may be disposed beneath apertures 108 or may be attached to the underside 204 of packaging platform 102 using any of a variety of different attachment mechanisms (e.g., hooks, detachable fasteners). As noted, containers 202 may be boxes, cartons, bags, or other vessels into which products may be included for shipment and/or delivery to customer locations. Containers 202 may be reusable. As illustrated, the container disposed beneath each respective aperture 108 is aligned with the aperture 108 to receive (e.g., catch) any items deposited through the respective aperture 108.

In one or more example implementations, a packaging machine may be aligned beneath each of apertures 108. Containers 202 may be engaged by the packaging machine and disengaged or released when the container 202 has received all of the items/products of the package being loaded therein. In one or more example implementations, package fitting modules may be included at the bottom of packaging platform 102 for each aperture 108. In one or more example implementations, each package fitting module may secure containers 202 to the underside 204 of packaging platform 102 by way of a vacuum lock, clamping mechanism, or other mechanism of mechanical attachment. The container 202 may be made of a flexible material or made of another more rigid type of material. Once a container 202 has received all of the items for a given package, the package fitting module may release the container 202 from packaging platform 102.

FIG. 3 illustrates an example architecture for product packaging engine 112 that may be executed by data processing system 106. In the example, product packaging engine 112 includes an order intake 302, a packager 304, a package assigner 306, and a route generator 308. In the example, product packaging engine 112 further is coupled with an order database 310 and a product database 312. In one or more embodiments order database 310 and product database 312 are stored within data processing system 106. In one or more other embodiments, order database 310 and/or product information database 312 are implemented as separate or remote data storage systems coupled to data processing system 106.

Order intake 302 is capable of receiving one or more orders from one or more different sources. For example, order intake 302 may receive orders from Web-based sources (e.g., online or Web-based stores) or other order entry systems. Order intake 302 may store received orders in order database 310. Order intake 302 is also capable of analyzing orders to determine which items are specified by each order and retrieving product information for the items from product database 312.

Packager 304 is capable of determining, based on the particular items of each order, a number of packages that will be required to fulfill the order. Packager 304 obtains information about the items of an order from order intake 302 and/or retrieves such information from product database 312. For a given order (e.g., each order), packager 304 is capable of determining the number of items on the order, a weight of each item of the order, the size (e.g., dimensions) of each item of the order, the shape of each item of the order, a type or classification of each item of the order, and/or which customer placed the order.

In one aspect, packager 304 may include logic for processing the product information. The logic is capable of comparing the order information described above against various rules for generating packages for the order. For example, the logic may specify compatibility among items based on product type or classification so that packager 304 may determine which products or types of products may be packaged together (e.g., placed in a same container) and which may not. For purposes of illustration, packager 304 may place cleaning products of an order in a separate package than food products of the same order. The logic may specify a maximum weight capacity of the containers (e.g., and therefore of any package created for the container), the dimensions of available containers that dictate the size of package that may be carried in the container, and the like. Packager 304 is capable of determining how many packages are required to fulfill an order based the aforementioned data relating to the items of the order and the capabilities of the container(s) available.

Package assigner 306 is capable of assigning packages, as formed by packager 304, to different ones of apertures 108. Route generator 308 is capable of generating a route for each of robotic vehicles 104. The routes generated by route generator 308 may be implemented concurrently by the robotic vehicles 104 so that each robotic vehicle may drop one or more products into the various apertures 108 visited by the robotic vehicle while traversing its assigned route. In this regard, the routes may intersect or follow a common segment, though at different times, to avoid collision.

In one or more embodiments, route generator 308 is programmed with knowledge of the product(s) carried by each robotic vehicle 104, the position of packages on packaging platform 102 (e.g., as assigned to apertures), and a map of packaging platform 102. Route generator 308 is capable of generating routes by, at least in part, evaluating collision detection and avoiding collisions. In one or more example implementations, route generator 308 may generate routes by ensuring that each robotic vehicle 104 visits an aperture 108 for which the robotic vehicle carries a product/item for a package assigned to the aperture 108. The routes may be timed to avoid collisions while robotic vehicles traverse the routes concurrently.

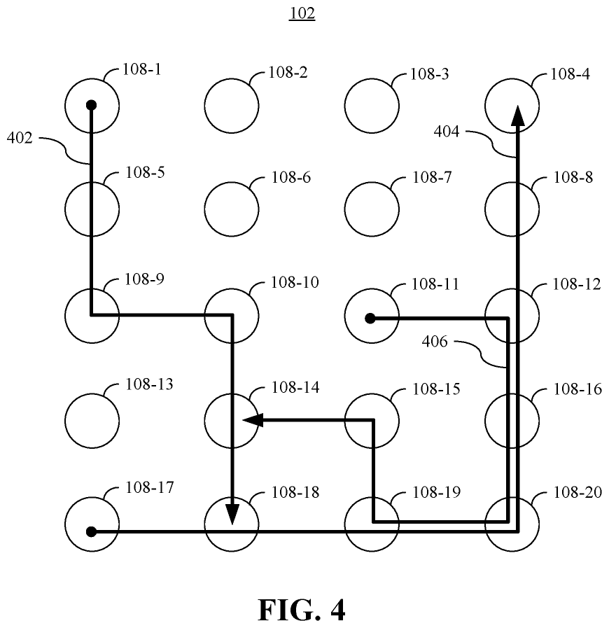

FIG. 4 illustrates an example of routes generated by product packaging engine 112 that may be provided to robotic vehicles 104 and traversed by robotic vehicles 104. In the example, product packaging engine 112 has generated routes 402, 404, and 406 that may be traversed by robotic vehicles 104-1, 104-2, and 104-3, respectively.

In the example, route 402 may begin at aperture 108-1 and travel along the path shown to visit apertures 108-5, 108-9, 108-10, and 108-14, and end at aperture 108-18. Route 404 may begin at aperture 108-17 and travel along the path shown to visit apertures 108-18, 108-19, 108-20, 108-16, 108-12, and 108-8, and end at aperture 108-4. Route 406 may begin at aperture 108-11 and travel along the path shown to visit apertures 108-12, 108-16, 108-20, 108-19, and 108-15, and end at aperture 108-14.

In the example, each of robotic vehicles 104 may deposit a product carried by the respective robotic vehicle into any of the apertures 108 visited along the route taken by that robotic vehicle 104. Further, though some apertures 108 are visited by more than one robotic vehicle 104 (e.g., some apertures are included in more than one route), the time at which each such aperture is visited by the different robotic vehicles 104 will be different so that one robotic vehicle 104 does not block any other robotic vehicle.

In one or more other example implementations, the order in which robotic vehicles travel over apertures common to more than one route may be determined according to a sequence in which items are to be dropped into the common aperture to complete the package assigned thereto. For example, route 402 and route 406 both encounter aperture 108-14. The order of arrival of the respective robotic vehicles following the routes may be timed so that the first robotic vehicle to encounter aperture 108-14 carries an item that is designated to be dropped first in the sequence of items to be dropped into the aperture thereby locating the first item at the bottom of the container. The second robotic vehicle to encounter aperture 108-14 carries an item to be dropped second in the sequence of items to be dropped into the aperture thereby locating the second item above the first item in the container.

Thus, each route, as generated by route generator 308, may specify a particular path that traverses over different apertures, may specify in which of the apertures the path crosses the robotic vehicle is to drop a package, how many packages are to be dropped (and optionally which type of package if the robotic vehicle carries more than one type of package), and/or pauses and/or delays to time operation of the robotic vehicle along the path defined by the route (e.g., to sequence the order in which different robotic vehicles encounter different apertures).

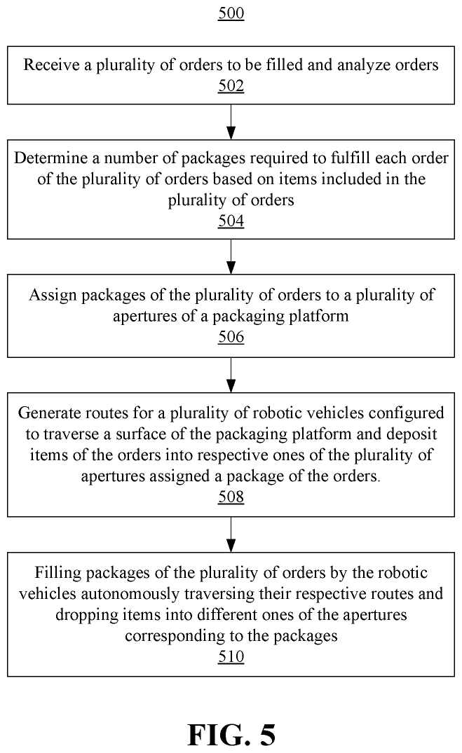

FIG. 5 illustrates an example method 500 of fulfilling orders using the system of FIG. 1. In block 502, order intake 302 receives a plurality or orders to be fulfilled. Order intake 302 may store the orders in order database 310. In response to receiving the plurality of orders, order intake 302 is capable of analyzing each order to identify the items specified by, or included in, each order. For example, order intake 302 is capable of determining the products from each order and fetching data for each product of each order from product database 312.

In block 504, packager 304 determines a number of packages required to fulfill each order of the plurality of orders. Packager 304 is capable of analyzing each order and determining whether multiple packages are needed to accommodate all of the products specified by the order. The number of packages required for each order may be determined, at least in part, based on the items included in the respective orders. For example, as discussed, the number of packages needed may be determined based, at least in part, on the types of products included in the same order, the weights of the products, and the dimensions of the products given the size and weight rating of the containers 202 being used. For each order, one or more packages may be needed for the order. That is, the products of the order may be subdivided into one or more different packages, where each package is placed into its own individual container 202.

In one or more example implementations, packager 304, having determined the number of packages needed for each order, is capable of assigning items of the order to the package or packages as the case may be. Thus, packager 304 is capable of determining the number of packages needed for each order and assigning items of the order to such packages.

In generating the packages, packager 304 is capable of determining a sequence of the items to be loaded into the container for each package. The sequence in which items are to be deposited may be determined based, at least in part, on one or more attributes of the items. For example, heavy items may be deposited prior to light items for a given package so that the heavier items are on the bottom of the container and do not crush lighter items. Similarly, larger items may be deposited prior to smaller items to promote greater stability in the contents of the package to avoid shifting of items in the container.

In block 506, package assigner 306 is capable of assigning packages of the plurality of orders to the plurality of apertures 108 of packaging platform 102. For example, package assigner 306 is capable of mapping packages of the orders to apertures 108. The mapping may by performed on a one-to-one basis. That is, each package may be assigned to a single aperture 108 and each aperture 108 may have at most one package assigned thereto at any given time.

In one or more embodiments, the number of orders that may be fulfilled concurrently may depend on the number of packages needed. Given that packages are mapped to apertures 108 on a one-to-one basis, so long as apertures 108 are available (e.g., have not been assigned a package), further orders may be selected for processing with the others currently allocated to apertures 108 of packaging platform 102.

In one or more example implementations, the mapping or assigning performed by package assigner 306 may be performed dynamically as orders are received and/or packages are released from apertures. For example, as one package is fully packed and the container including the package is released or is disengaged from packaging platform 102, the aperture 108 becomes available for mapping to a new package. Package assigner 306 is capable of assigning a new package for the same or a different order to that available aperture.

In one or more example implementations, package assigner 306 is capable of assigning packages to apertures 108 so that movement of robotic vehicles 104 is minimized. As an illustrative and non-limiting example, product packaging engine 112 is capable of selecting packages from the plurality of orders that include same items and assigning the selected packages that include same items to apertures of the packaging platform within a predetermined distance of one another. In one or more examples, such packages are assigned to adjacent apertures 108. This means that the robotic vehicle 104 that contains the product(s) common to both packages can deposit the product(s) into the apertures to which the packages have been assigned with minimal movement, e.g., by moving to an adjacent aperture.

In block 508, route generator 308 is capable of generating routes for the plurality of robotic vehicles. The plurality of robotic vehicles will be configured to traverse a surface (e.g., top surface 110) and deposit items of the orders into respective ones of the plurality of apertures assigned a package of the orders. In one or more example implementations, route generator 308 is capable of generating routes based on the current (e.g., starting) position of each respective robotic vehicle 104, the product or products carried by each respective robotic vehicle 104, and the different products specified by each of the orders being fulfilled.

In addition or in the alternative, route generator 308 is capable of generating routes based on the determined sequence in which the items of the plurality of orders are to be deposited into determined packages for the plurality of orders. As such, route generator 308 is capable of generating the routes to meet the established sequencing of products being deposited.

In one or more example implementations, each robotic vehicle 104 may carry a single and different item. Accordingly, the route for each robotic vehicle 104, as generated by route generator 308, defines a path on packaging platform 102 that visits apertures 108 for the plurality of orders requiring items carried by each respective robotic vehicle 104. In one or more other examples, each robotic vehicle 104 may carry more than one product.

In block 510, the robotic vehicles are capable of autonomously traversing their respective routes and dropping items into different ones of the apertures corresponding to the packages to fulfill packages of the plurality of orders. In one or more example implementations, as each robotic vehicle 104 travels over packaging platform 102, the robotic vehicle 104 is capable of aligning with the various apertures 108 into which products are to be dropped.

Once a robotic vehicle 104 drops a product through an aperture 108, the product drops into the container for that aperture 108. The multiple robotic vehicles 104 are capable of operating and navigating autonomously and in a collaborative manner to complete the orders. It should be appreciated that the various operations described herein may be performed concurrently for the plurality of orders such that packages of the plurality of orders are filled by robotic vehicles 104 traversing their respective routes over packaging platform 102 concurrently.

After required products are dropped, product packaging engine 112 is capable of completing the orders. Product packaging engine 112 may, for example, signal another system (e.g., the packaging machine(s)) to remove the containers that are complete so that the aperture 108 with which the container was be associated is free for reassignment to a different package.

In one or more example implementations, product packaging engine 112 is capable of predicting additional orders based, at least in part, on historical order data (e.g., which items are ordered and quantities of items ordered), the timing of orders (e.g., time of year and/or time of day), and proactively fill the robotic vehicles with product (including changing the product that a particular robotic vehicle carries) so that the robotic vehicles may continue dropping products in fulfillment of received orders.

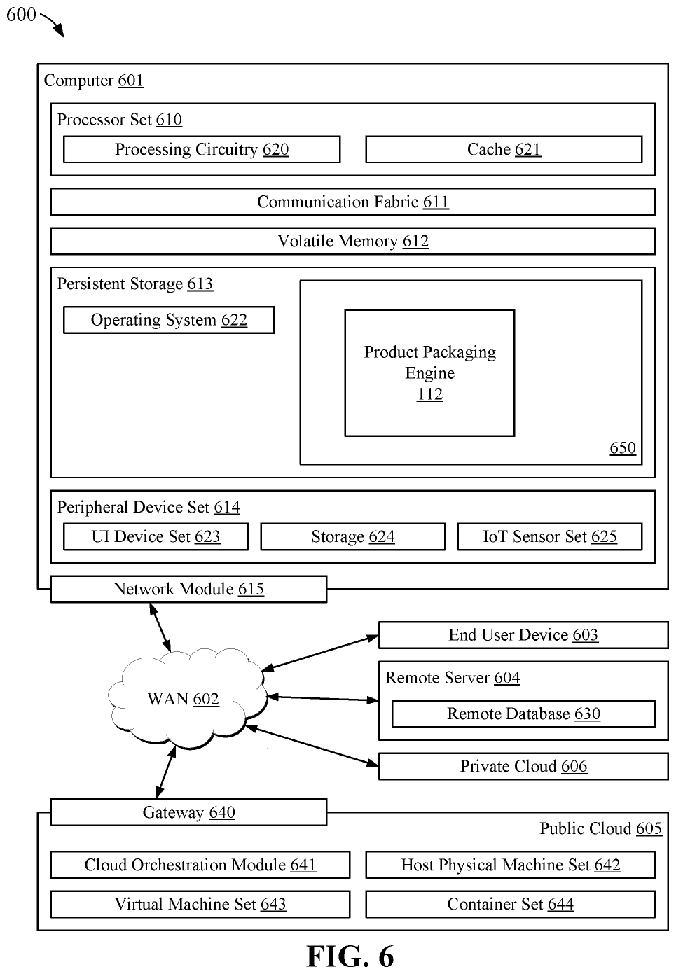

FIG. 6 illustrates an example implementation of a computing environment 600. Computing environment 600 contains an example of an environment for the execution of at least some of the computer code in block 650 involved in performing the inventive methods, such as product packaging engine 112 implemented as executable program code or instructions. Product packaging engine 112 is capable of performing the various operations described herein. In addition to block 650, computing environment 600 includes, for example, computer 601 (e.g., data processing system 106), wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors (e.g., hardware processors) of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (e.g., where computer 601 locally stores and manages a large database such as order database 310 and/or product database 312) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (e.g., embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (e.g., a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. As noted, in some embodiments, order database 310 and/or product database 312 may be implemented as remote database 630.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C.” “at least one of A, B, or C,” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, using computer hardware, a number of packages required to fulfill a plurality of orders based on items included in the respective plurality of orders;
assigning, using the computer hardware, packages of the plurality of orders to a plurality of apertures of a packaging platform; and
generating, using the computer hardware, routes for a plurality of robotic vehicles configured to carry items of the orders and traverse a surface of the packaging platform;
wherein the plurality of robotic vehicles, in traversing the routes, are configured to deposit the items of the orders into respective ones of the plurality of apertures assigned a package of the orders.

2. The method of claim 1, further comprising:
filling each package of the plurality of orders by the plurality of robotic vehicles autonomously traversing their respective routes and dropping items into different ones of the apertures corresponding to the packages.

3. The method of claim 1, wherein:
each robotic vehicle carries a different item; and
the route for each robotic vehicle defines a path on the packaging platform that visits apertures for the plurality of orders requiring items carried by the respective robotic vehicle.

4. The method of claim 1, wherein the determining, the assigning, and the generating are performed concurrently for the plurality of orders such that packages of the plurality of orders are filled by the robotic vehicles traversing their respective routes concurrently.

5. The method of claim 1, wherein the number of packages required to fulfill one or more of the plurality of orders is greater than one and wherein each package of the order is assigned to a different aperture.

6. The method of claim 1, further comprising:
determining a sequence in which items of the plurality of orders are to be deposited into the packages for the plurality of orders based on one or more attributes of the items;
wherein the routes for the plurality of robotic vehicles are determined based, at least in part, on the sequence in which the items of the plurality of orders are to be deposited into the packages.

7. The method of claim 1, wherein the assigning each package of the order to the aperture includes:
determining selected packages from the plurality of orders that include same items; and
assigning selected packages that include same items to apertures of the packaging platform within a predetermined distance of one another.

8. The method of claim 7, wherein the selected packages are assigned to apertures adjacent to one another.

9. A system, comprising:
a packaging platform comprising a plurality of apertures;
a plurality of robotic vehicles configured to carry items, traverse a surface of the packaging platform, and deposit the items into different ones of the apertures according to a plurality of orders; and
a computer system in communication with the plurality of robotic vehicles and configured to generate routes for the plurality of robotic vehicles to traverse the surface of the packaging platform and deposit the items into the apertures.

10. The system of claim 9, wherein the computer system is configured to determine a number of packages required to fulfill each order of the plurality of orders based on items included in the respective plurality of orders and assign packages of the plurality of orders to different ones of the plurality of apertures of the packaging platform.

11. The system of claim 10, wherein the assigning each package of the order to the aperture includes:
determining selected packages from the plurality of orders that include same items; and
assigning selected packages that include same items to apertures of the packaging platform within a predetermined distance of one another.

12. The system of claim 11, wherein the selected packages are assigned to apertures adjacent to one another.

13. The system of claim 9, wherein the plurality of apertures are arranged in a grid.

14. The system of claim 9, wherein:
each robotic vehicle carries a different item; and
the route for each robotic vehicle defines a path on the packaging platform that visits apertures for the plurality of orders requiring items carried by the respective robotic vehicle.

15. The system of claim 9, wherein:
the computer system is configured to determine a sequence in which items of the plurality of orders are to be deposited into the packages for the plurality of orders based on one or more attributes of the items; and
the routes for the plurality of robotic vehicles are determined based, at least in part, on the sequence in which the items of the plurality of orders are to be deposited into the packages.

16. A system, comprising:
one or more processors configured to execute operations including:
determining a number of packages required to fulfill a plurality of orders based on items included in the respective plurality of orders;
assigning packages of the plurality of orders to a plurality of apertures of a packaging platform; and
generating routes for a plurality of robotic vehicles configured to carry items of the orders and traverse a surface of the packaging platform;
wherein the plurality of robotic vehicles, in traversing the packaging platform based on the routes, are configured to deposit the items of the orders into respective ones of the plurality of apertures assigned a package of the orders.

17. The system of claim 16, wherein the one or more processors are configured to execute operations including:
filling each package of the plurality of orders by the plurality of robotic vehicles autonomously traversing their respective routes and dropping items into different ones of the apertures corresponding to the packages.

18. The system of claim 16, wherein:
each robotic vehicle carries a different item; and
the route for each robotic vehicle defines a path on the packaging platform that visits apertures for the plurality of orders requiring items carried by the respective robotic vehicle.

19. The system of claim 16, wherein the one or more processors are configured to execute operations including:
determining a sequence in which items of the plurality of orders are to be deposited into the packages for the plurality of orders based on one or more attributes of the items;
wherein the routes for the plurality of robotic vehicles are determined based, at least in part, on the sequence in which the items of the plurality of orders are to be deposited into the packages.

20. The system of claim 16, wherein the assigning each package of the order to the aperture includes:
determining selected packages from the plurality of orders that include same items; and
assigning selected packages that include same items to apertures of the packaging platform within a predetermined distance of one another.
